(19) United States
(12) Patent Application Publication
(10) Pub. No.: US 2007/0153134 A1
(43) Pub. Date: Jul. 5, 2007

(54) TELEVISION RECEIVER WITH A FLAT SCREEN DISPLAY

(76) Inventors: Ulrich Sieben, Vorstetten (DE); Miodrag Temerinac, Gundelfingen (DE)

Correspondence Address: Patrick J. O'Shea, Esq.;O'Shea, Getz & Kosakowski, P.C., Suite 912, 1500 Main Street, Springfield, MA, 01115, US

(21) Appl. No.: 11/618,332

(22) Filed: Dec. 29, 2006

(30) Foreign Application Priority Data
Jan. 4, 2006 (DE) 10 2006 000 890.1

(51) Int. Cl. H04N 5/44; H04N 5/64

(52) U.S. Cl. 348/725; 348/553; 348/839

(57) ABSTRACT

Television receiver comprising a flat screen display which has a component interface unit spatially separate from the television receiver for the external terminals, such as, for example, SCART sockets or speaker terminals, the component interface unit being connected through at least one high-capacity bus connection to the television receiver. The bus connection is connected in the spatially separate component interface unit to first bus interfaces for signals to be fed in and out, and is connected in the television receiver to second bus interfaces.

### PRIORITY INFORMATION

This patent application claims priority from German patent application 10 2006 000 890.1 filed Jan. 4, 2006, which is hereby incorporated by reference.

### BACKGROUND INFORMATION

The invention relates to a television receiver with a flat screen display.

Flat panel televisions (e.g., LCD or plasma) are suitable for hanging on a wall analogous to a picture. One disadvantage with this mounting is that the connection sockets installed on the side or at the rear are no longer readily accessible, and in particular, the various signal cables to the speakers, video recorder, and DVD player disturb the visual impression as a result of the wall mounting. While the various cables can in fact be accommodated in a cable conduit mountable on the wall, the size required nevertheless makes an objectionable impression.

There is a need for an improved technique for connecting television input and output devices such as cable and satellite receivers and speakers to the television.

### SUMMARY OF THE INVENTION

A component interface unit spatially separated from a flat panel television display receives external connections that are connected to the television receiver through a bus system. The term “high-capacity” here means that the bus connection is of the highest frequency possible in order to carry a large quantity of data through the fewest wires possible, with the result that the bus system has only a few bus leads. In comparison with conventional cable connections, a bus of this type is relatively inconspicuous and can easily be routed between the separate device and the television receiver.

If appropriate high-frequency wireless bands are employed, this bus can also be designed to operate wirelessly. Since only relatively short distances must be covered, the required transmission power is low. In addition to the transmission of video and audio signals, control signals may also be transmitted which the television receiver receives through an infrared sensor element. The control signals may be supplied not only to the actual television receiver, but they may also implement control functions in the separate device and the devices connected thereto.

These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1 illustrates a flat screen television receiver that is connected to a component interface unit via a broadband bus; and

FIG. 2 is a block diagram illustration of the bus connection between the component interface unit and the television receiver.

### DETAILED DESCRIPTION OF THE INVENTION

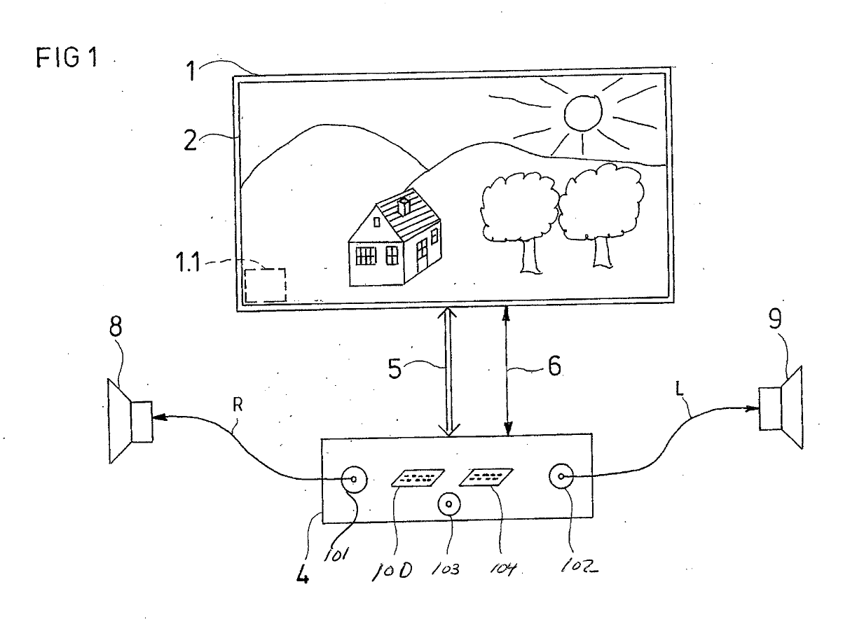

FIG. 1 schematically illustrates a television receiver 1 with an associated flat screen display 2. Flat screen displays of this type provide a low profile depth suitable for hanging on a wall like a picture. The associated electronics may be accommodated in the flat television receiver 1. Difficulties are caused, however, by loudspeakers 8, 9 and the various connection sockets 100-104 for external devices. In principle, the connection sockets can continue to be inserted on the rear side of the flat television receiver 1, or on the lateral surfaces thereof, and are thus invisible from the front. In the case of a wall mounting, however, the cables and associated plugs to be connected detract from the overall visual impression, in particular, if the cables have to be routed on the rear since the television receiver must then be moved away from the wall.

These disadvantages are eliminated by the spatial separation of connection sockets 100-104 from the television receiver 1 by using a broadband bus 5 for the video and audio signals, a simple control bus 6 for the control signals, and a spatially separate component interface unit 4 to accommodate all, or at least the especially obtrusive connection sockets. In either the component interface unit 4 or the television receiver 1, the signals are converted into bus signals and transmitted as data through the bus connections 5, 6 to the other side where they are normally converted back into the original signals. It is of course understood that the television receiver 1 may have its own separate connection sockets, which are usable in case of a different mode of setup for the television receiver, independently of the sockets 100-104 in the component interface unit 4.

Audio and video signals are transmitted through the broadband bus 5 that has only a few bus leads (e.g., between two and five). Control signals are transmitted through the control bus 6. The control signals originate either from a sensor element 1.1 driven by a remote control (not shown), the television receiver 1, the component interface unit 4, or one of the devices connected thereto.

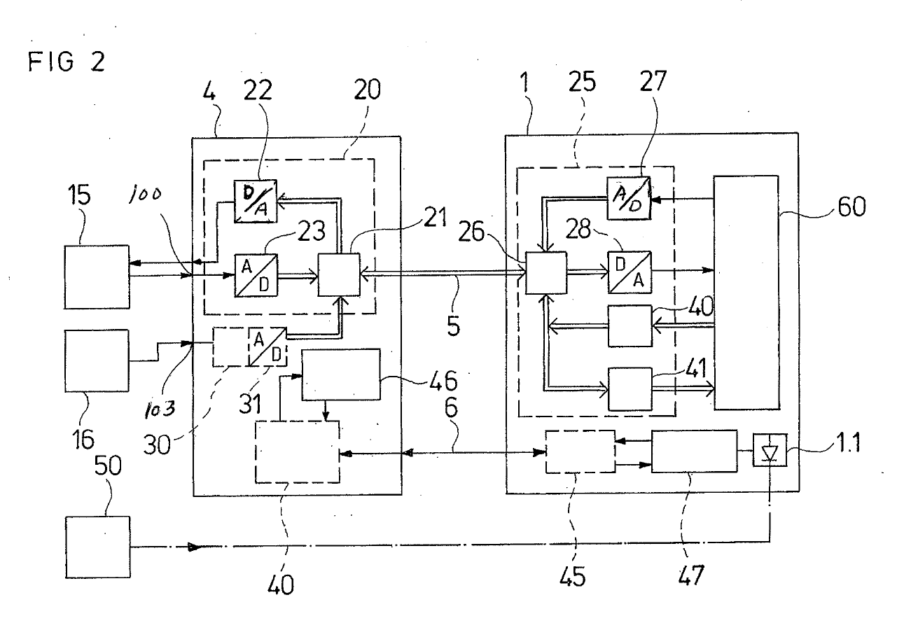

The component interface unit 4 contains, for example, a first and second “Syndicat des Constructeurs d'Appareiles Radio Recepteurs et Televiseurs” (SCART) connection socket 100, 104, respectively to connect a video recorder and a DVD player. In addition, a speaker socket 102 is provided which supplies a right-channel audio signal R to the speaker 8, and a speaker socket 101 which supplies a left-channel audio signal L to the speaker 9. In the case of surround sound systems, more speakers are added. Power stages are required in the component interface unit 4 for the speaker sockets if active speaker components 8, 9 are not used. The component interface unit 4 may also contain an antenna socket 103 through which a high-frequency antenna signal is supplied from an antenna system or a satellite receiver 16 (see FIG. 2).

FIG. 2 is a block diagram illustration of the bus connections between the component interface unit 4 and the television receiver 1. The component interface unit 4 includes a first broadband bus interface 20 that is bi-directionally connected to the broadband bus 5. The television receiver 1 includes a second broadband bus interface 25 that is also bi-directionally connected to the broadband bus in order to communicate with the component interface unit 4 via the first broadband bus interface 20.

The component interface unit 4 also includes a first control bus interface 40 that is bi-directionally connected to the control bus 6. A second control bus interface 45 is located in the television receiver 1, and is bi-directionally coupled to the control bus 6 to communicate with the first control bus interface 40.

Referring still to FIG. 2, a video recorder 15, for example is connected through the first SCART connection socket 100 to the first bus interface 20. For the sake of simplification, of the twenty-one contacts of the SCART connection socket only one input line and one output line are shown. The actual transmit-receive device for the broadband bus 5 is in the first broadband bus interface 20 of the circuit block 21 and in the second broadband bus interface 25 of the circuit block 26. These circuit blocks receive or transmit digital data through the broadband bus 5. If the objective is to transmit analog signals through the broadband bus 5, these are digitized by analog-to-digital converter 23. On the other side of the broadband bus 5, that is, in the second broadband bus interface 25, the re-conversion is effected by a digital-to-analog converter 28. For the reverse signal path, the second broadband bus interface 25 contains an analog-to-digital converter 27, while the first broadband bus interface 20 contains an associated digital-to-analog converter 22.

A video and audio signal processing device 60 is connected to the second broadband bus interface 25. Since modem television receivers normally have an internal digital signal processing device, it is expedient that the circuit block 60 on the bus can transmit or receive data in addition to analog signals. Data are collected in the processing unit 60 normally as parallel bit streams of 8 to 32-bit width which are of course unsuited for direct transmission through the broadband bus 5. Code converters 40 and/or 41 are required for adapting to the high data rate and narrow bit width of the broadband bus 5. Given the high data rate, it is possible to reduce the bit width of the audio and video data. In the case of purely serial transfer of individual bits, the number of bus leads is at its lowest and a twisted pair with appropriate transmission properties is sufficient in the form of a two-wire bus lead. In the event digital data are received from outside, or outputted to the outside, through the first broadband bus interface 20, then code converters are also required here.

In FIG. 2, the satellite receiver 16 is connected to the antenna socket 103, and the received signals are translated by a frequency conversion device 30 to a lower frequency position, then digitized by an analog-to-digital converter 31. These data are fed to the transmit-receive device 21, which relays the signals through the broadband bus 5 to the television receiver 1. In the case of analog-to-digital conversion in the converters 23, 31, the act of digitization is appropriately adapted to the data rate of the broadband bus 5.

The control bus 6 with its first and second control bus interfaces 40, 45, is connected to a control device 46 in the component interface unit 4 or a control device 47 in the television receiver 1. For example, the IR sensor element 1.1 supplies control signals that are decoded in the control device 47. To the extent that these control signals relate to the component interface unit 4, or the devices 15, 16 connected thereto, the control signals are converted into data in the second control bus interface 45, then transferred through the control bus 6 to the first control bus interface 40 that implements re-conversion, thereby generating control signals for the control device 46. The infrared control signals for the sensor element 1.1 may originate from a remote control transmitter 50. While the sensor element 1.1 may be associated with the component interface unit 4, this is, however, disadvantageous since the component interface unit 4 should be accommodated in the most concealed manner possible for reasons of visual appearance.

The system comprising the broadband bus 5 and the associated first and second broadband bus interfaces 20, 25 becomes simpler if the bidirectional configuration of the broadband bus 5 is split into two unidirectional busses with corresponding interfaces. For a sufficiently high transfer rate, this requires, for example, two twisted pairs which are nevertheless very inconspicuous relative to the original cables. The need for all conventional measures to avoid conflicts is then eliminated when both the first and second broadband bus interfaces 20, 25 want to access the broadband bus 5 at the same time. In addition, the required data rate is halved by this split.

FIG. 2 shows the control bus 6 as a separate bus. Since, however, what is involved here is the exchange of a relatively small amount of data, this data can be readily superimposed on the video and audio data on the broadband bus 5. A separate data area of the transferred data packets, or an area within the header, is suitable for this purpose. Since the transferred data relate to different terminals, and then different contact pins within these terminals, it is necessary here in any case that, among other things, address information be supplied along with the transferred data. This is effected with the normally employed packet information in the header.

Although the present invention has been illustrated and described with respect to several preferred embodiments thereof, various changes, omissions and additions to the form and detail thereof, may be made therein, without departing from the spirit and scope of the invention.

What is claimed is:

1. A television receiver comprising a flat screen display, where for external terminals such: as, for example, SCART connection sockets or speaker terminals the television receiver has a device component spatially separate from the television receiver, which device is connected through at least one bus connection to the television receiver, wherein the bus connection is connected through first bus interfaces to the external terminals in the spatially separate device component, and through second bus interfaces to the television receiver.

2. The television receiver of claim 1, where at least one analog-to-digital converter for digitizing analog signals before the bus transfer and at least one digital-to-analog converter for re-conversion after the bus transfer are provided in the first or second interfaces.

3. The television receiver of claim 1, where a first data converter is coupled to the first and second bus interfaces for the bus connection, which data converter reduces the bit width of digital signals before the bus transfer, while a second data converter enlarges the bit width after the bus transfer, wherein the data rate is increased in the event of bit width reduction and decreased in the event of bit width enlargement.

4. The television receiver of claim 1, where the bus connection has fewer than bus 6 leads.

5. The television receiver of claim 1, where the bus connection is wireless.

6. The television receiver of claim 3, where the bus connection contains at least one twisted pair as the bus lead.

7. The television receiver of claim 1, where the spatially separate device component has a terminal for an antenna signal and a processing unit for the antenna signal.

8. The television receiver of claim 7, where the processing unit contains a frequency converter and a digitization stage connected thereto.

9. A component interface unit that routes audio/video data between audio/video components and a spatially separated television receiver via a broadband bus, the component interface unit comprising:
a broadband bus interface that receives audio/video data from an audio/video component and arbitrates transmitting the received audio/video data onto the broadband bus and receiving data from the broadband bus.

10. A component interface unit that routes audio/video data between audio/video components and a spatially separated television receiver via a broadband bus, the component interface unit comprising:
an first analog-to-digital converter that receives first audio/video data from an audio/video component and provides first digitized data;
a transceiver that receives the digitized data and transmits the first digitized data onto the broadband bus, and receives digitized television receiver data via the broadband bus; and
a digital-to-analog converter that receives and converts the digitized television receiver data to analog television receiver data and transmits the analog television receiver data to the audio/video component.

11. The component interface unit of claim 10, where the broadband bus is wireless and the transceiver transmits the digitized data via a wireless channel and receives the digitized television receiver data via the wireless channel.

12. The component interface unit of claim 10, further comprising:
a first SCART interface that is configured and arranged to connect with a video recorder that also provides the audio/video data;
a plurality of loudspeaker interfaces; and
an antenna socket that provides second audio/video data to a second analog-to-digital converter that provides second digitized data to the transceiver that selectively transmits the first and second digitized data.
